(19) United States
(12) Patent Application Publication
(10) Pub. No.: US 2009/0080818 A1
(43) Pub. Date: Mar. 26, 2009

(54) SPHERICAL BEARING WITH RESIN LINER AND ROD END BEARING

(76) Inventors: Gen Sasaki, Minamisaku-gun (JP); Mitsunori Oura, Kitasaku-gun (JP)

Correspondence Address: BRINKS HOFER GILSON & LIONE, P.O. BOX 10395, CHICAGO, IL, 60610, US

(21) Appl. No.: 12/236,710

(22) Filed: Sep. 24, 2008

(30) Foreign Application Priority Data
Sep. 26, 2007 (JP) 2007-248688

(51) Int. Cl. F16C 11/08

(52) U.S. Cl. 384/203

(57) ABSTRACT

A spherical bearing with resin liner comprises an inner ring, an outer ring, an opening portion, a notched portion, and a resin liner portion. The inner ring has a convex spherical outer surface and a shape in which opposing end portions of a sphere are cut off, and the outer ring has a concave inner surface which faces the outer surface of the inner ring having a predetermined clearance therebetween. The opening portion is provided at the outer ring and has an inner diameter smaller than the outer diameter of the inner ring, and the opening portion communicates with a space surrounded by the inner surface of the outer ring. The notched portion is provided at an edge of the opening portion for inserting the inner ring into the outer ring, and the resin liner portion continuously fills the clearance and the notched portion.

### RELATED APPLICATIONS

This application claims priority under 35 U.S.C. §119 to Japanese Patent Application No. JP2007-248688 filed Sep. 26, 2007, the entire content of which is hereby incorporated by reference.

### BACKGROUND OF THE INVENTION

1. Technical Field

The present invention relates to a spherical bearing with resin liner and a rod end bearing including the spherical bearing capable to support a large thrust load.

2. Background Art

A spherical bearing has a basic structure in which an inner ring having a convex spherical outer surface is slidably supported by an outer ring having a concave spherical inner surface. For example, such spherical bearings are disclosed in Japanese Unexamined Patent Applications Publication Nos. 7-42729 and 6-200931, Japanese Examined Utility Model Application Publication No. 3-20573, and Japanese Unexamined Utility Model Application Publication No. 6-40448.

FIGS. 9A to 9C are cross sectional views showing a structure of a spherical bearing with resin liner formed by a conventional technique. FIG. 9A shows the overall structure in a cross sectional view, and FIG. 9B shows a condition in which the inner ring is overloaded and unable to withstand the thrust load in the axial direction, and the inner ring is pushed out from the inside of outer ring. FIG. 9C shows the relationship between the position of the center of curvature of the outer ring inner spherical surface and the position of the center of curvature of the inner ring outer spherical surface.

As shown in FIG. 9A, the spherical bearing with resin liner formed by a conventional technique has a basic structure in which a metallic inner ring 2 is supported by a metallic outer ring 1 via a resin liner 3. According to this structure, the inner ring 2 is rotatably supported inside the outer ring 1 by the resin liner 3 injected by an injection molding method. Resin securing grooves 4 are formed at the inner surface of the outer ring 1 so as to secure the resin liner 3 on the inner spherical surface of the outer ring 1. In this structure, when a torque is applied to the inner ring 2, the inner ring 2 slides on the lubricative resin liner 3 and rotates in the outer ring 1. This is the basic structure and the operating principle of the spherical bearing with resin liner.

In the spherical bearing with resin liner shown in FIGS. 9A to 9C, since the inner ring 2 is inserted into the outer ring 1 during assembly, the opening diameter ΦA at the end surface of the outer ring 1 must be larger than the spherical diameter SΦB of the inner ring 2. Therefore, a large clearance is formed between the concave spherical surface of the outer ring 1 and the convex spherical surface of the inner ring 2, and the inner ring 2 cannot be held inside the outer ring 1 in this condition. In that case, as shown in FIG. 9A, a resin is injected into the clearance by the injection molding method and is solidified so as to form a resin liner 3, whereby the inner ring 2 is supported by the resin liner 3 so as not to be pushed out of the outer ring 3.

In the conventional spherical bearing with the resin liner, when a thrust load is applied to the inner ring 2 in a thrust direction (axial direction; in this case, the horizontal direction of the paper surface), the inner ring 2 is pressed in the axial direction and tends to move axially. In this condition, since the spherical diameter SΦB of the inner ring 2 is smaller than the opening diameter ΦA of the outer ring 1, only the resin liner 3 supports the thrust load. Therefore, when the resin liner 3 cannot support the thrust load any longer, the resin liner 3 is largely deformed or is fluidized. Then, as the structure for supporting the inner ring 2 cannot support the thrust load, the inner ring 2 is pushed out from the outer ring 1. That is, the spherical bearing is damaged and can no longer function as a slide bearing. The thrust load corresponding to the condition when the inner ring 2 is pushed out or the resin liner 3 is deformed whereby the spherical bearing no longer functions as a bearing is defined as “push-out load”. The push-out load is one of the parameters for evaluating the load capacity of a spherical bearing. The push-out load can be measured as the maximum load in a load-displacement curve obtained by gradually increasing the thrust load applied to an end surface of the inner ring. In the structure shown in FIGS. 9A to 9C, the load capacity in the thrust direction (arrow direction in FIG. 9B) depends on the shear strength of the resin liner 3. The load capacity increases as the thickness of the resin liner 3 decreases. As described above, since the diameter ΦA must be larger than the spherical diameter SΦB (ΦA>SΦB), the thickness of the resin liner 3 cannot be so small. Therefore, in the spherical bearing shown in FIGS. 9A to 9C, the load capacity cannot be easily increased significantly.

Since the diameter ΦA must be larger than the diameter SΦB, as shown in FIG. 9C, the center of curvature O₀ of the concave spherical surface 1a inside the outer ring 1 is positioned farther from the outer ring 1 than a center of curvature O of the convex spherical surface 2a outside the inner ring 2. Therefore, the clearance between the concave spherical surface 1a inside the outer ring 1 and the convex spherical surface 2a outside the inner ring 2 (that is, the space filled by the resin liner 3) increases toward the opening. In this structure, the resin liner is easily deformed and would be forced out to the outside when a thrust load is applied. Accordingly, the load capacity cannot be greatly increased.

When the inner ring 2 rotates, the resin liner 3 is dragged by the inner ring 2 and co-rotates with the inner ring 2. In the structure shown in FIGS. 9A to 9C, the resin securing grooves 4 prevent this problem. In order to secure the rein liner 3 more strongly, the grooves should be deepened and be increased in number. However, if the resin securing grooves 4 are deepened and are increased in number, the strength of the outer ring 1 is decreased, and the strength of the bearing is thereby decreased.

### DISCLOSURE OF THE INVENTION

In view of the above circumstances, an object of the present invention is to provide a spherical bearing with resin liner, in which the load capacity is greatly increased, the outer ring has an appropriate strength, and the resin liner does not co-rotate with the inner ring.

According to the first aspect of the present invention, a spherical bearing with resin liner comprises an inner ring, an outer ring with an opening portion and a notched portion for inserting the inner ring into the outer ring, and a resin liner portion. The inner ring has a convex spherical outer surface and a shape such like a sphere wherein the opposing end portions are cut off. The outer ring has a concave inner surface which faces the outer surface of the inner ring maintaining a predetermined clearance therebetween. The opening portion provided at the outer ring has an inner diameter that is smaller than the outer diameter of the inner ring, and the opening portion communicates with a space surrounded by the inner surface of the outer ring. The notched portion is provided at an edge of the opening portion, and the resin liner portion continuously fills the clearance and the notched portion.

In the first aspect of the present invention, the concave inner surface means that the inner surface is formed in a manner so that the inner diameter at the center portion of the outer ring is larger than the opening diameter of the opening portion. According to this structure, the opening diameter of the end portion of the outer ring can be smaller than the spherical diameter of the inner ring. The inner ring can be inserted into the outer ring by using the notched portion. Accordingly, the spherical diameter of the inner ring is not limited, and the inner ring can be freely designed.

The inner diameter of the opening portion of the outer ring is set to be smaller than the spherical diameter of the inner ring. Therefore, when a thrust load is applied, the load applied from the inner ring to the resin liner is supported by a part of the concave surface of the outer ring. In this portion, the resin liner is compressed in the thickness direction, whereby the load capacity depends not only on the shear strength of the resin liner, but also on the compressive strength. Since the compressive strength of the resin liner is larger than the shear strength, the structure which supports the thrust load by the compression of the resin liner as described above, can receive a thrust load larger than a case according to the conventional technique in which the thrust load is supported by using the shear strength of the resin liner. Additionally, when the outer ring is made of a metal which has greater rigidity than that of a resin liner, the bearing can withstand a larger thrust load by receiving the thrust load in the concave surface of the metallic outer ring.

Since the opening diameter of the end portion of the outer ring can be made smaller than the spherical diameter of the inner ring, it is not necessary to make the clearance between the concave surface inside the outer ring and the convex spherical surface outside the inner ring increasing toward the opening. Therefore, it is possible to adopt a structure wherein the resin liner is not easily forced out to the outside when a thrust load is applied. This is an additional advantage to support a larger thrust load.

The resin for forming the resin liner is continuously injected into the clearance between the concave surface and the convex spherical surface and the notched portion to fill all the space. Therefore, after the resin has solidified, an integral structure is formed such that a protruding portion connected to the resin liner is fitted in the notched portion. Thus, the resin liner is more strongly secured inside the outer ring, thereby effectively preventing the resin liner from co-rotating with the inner ring. Accordingly, it is not necessary to provide grooves to secure the resin liner inside the outer ring, and even when grooves are provided, the size and the number thereof can be selected so as not to affect the strength of the outer ring.

According to the second aspect of the present invention, at least a part of the inner surface may have a concave spherical surface. By forming a concave spherical surface at least at a part of the inside surface of the outer ring, the resin liner at the concave spherical portion may have a load applied thereto uniformly.

According to the third aspect of the present invention, the clearance between the inner ring and the outer ring may decrease from the center portion of the inner surface toward the opening portion of the outer ring. According to this structure, the resin liner can be formed so as to have a thickness distribution such that the resin liner is not easily forced out from the clearance to the outside when a thrust load is applied. Therefore, the bearing can receive a larger thrust load.

According to the fourth aspect of the present invention, the concave spherical surface of the inner surface of the outer ring may have a center of curvature that is positioned nearer the outer ring than the center of curvature of the convex spherical surface of the outer surface of the inner ring. According to the fourth aspect of the present invention, the third aspect of the present invention can be performed.

According to the fifth aspect of the present invention, a rod end bearing comprises the spherical bearing with resin liner of the present invention, and further comprises a screw portion that is provided at the outer ring and extends in a radial direction. According to the fifth aspect of the present invention, a rod end bearing can have advantages described in the first aspect of the present invention.

According to the present invention, a spherical bearing with resin liner, in which the load capacity is greatly increased, the outer ring strength is assured, and the co-rotation of resin liner is prevented, can be provided.

### BRIEF DESCRIPTION OF DRAWINGS

FIG. 1 is a perspective view showing a structure of a spherical bearing with resin liner according to the present invention.

FIGS. 2A and 2B show a structure of an outer ring of a spherical bearing with resin liner according to the present invention. FIG. 2A shows a perspective view, and FIG. 2B shows a front view.

FIGS. 3A and 3B are sectional side views showing a structure of an outer ring of a spherical bearing with resin liner according to the present invention.

FIGS. 4A to 4E are exploded views of an assembly process and show an example of assembly conditions of a spherical bearing with resin liner according to the present invention.

FIG. 5 is a cross sectional view showing a structure of a spherical bearing with resin liner according to the present invention.

FIG. 6 is a cross sectional view showing a structure of a spherical bearing with resin liner according to the present invention.

FIGS. 7A to 7C are perspective views showing embodiments 1 to 3 of a rod end bearing according to the present invention.

FIGS. 8A and 8B are sectional side views showing structures of outer rings of other spherical bearings with resin liner according to the present invention.

FIGS. 9A to 9C are sectional side views showing a structure of a conventional spherical bearing with resin liner.

### PREFERRED EMBODIMENTS OF THE INVENTION

### (1) First Embodiment

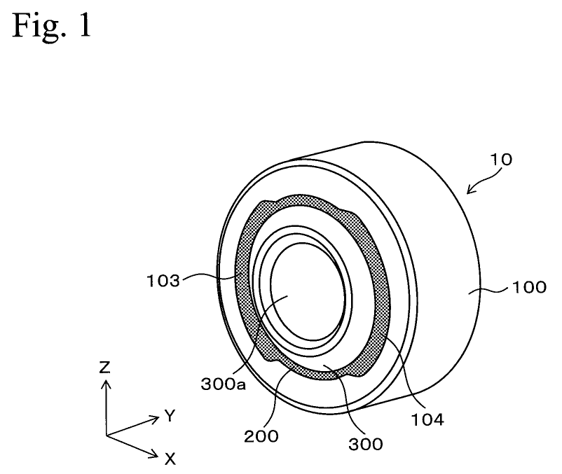

An embodiment using the present invention will be described hereinafter. FIG. 1 is a perspective view showing a structure of a spherical bearing with resin liner according to the present invention. FIG. 1 shows the spherical bearing 10 with resin liner having a basic structure comprising an inner ring 300 rotatably supported inside an outer ring 100 via a resin liner 200. The outer ring 100 and the inner ring 300 are made of metal in order to ensure the strengths thereof. The materials of the outer ring 100 and the inner ring 300 are not limited to metal as long as the strengths thereof satisfy the requirement. For example, sintered alloy, engineering plastic, or composite material may be used.

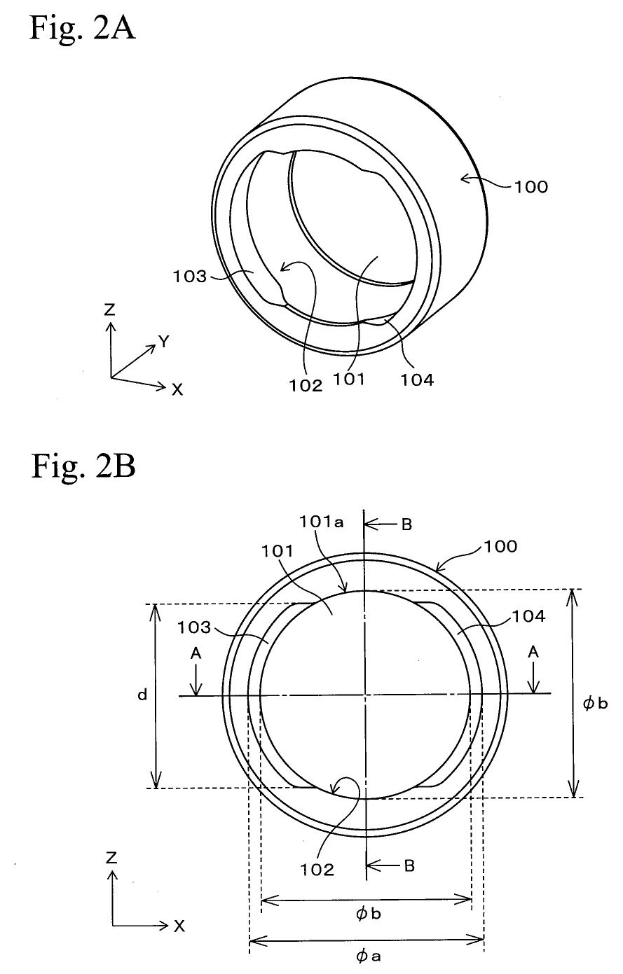

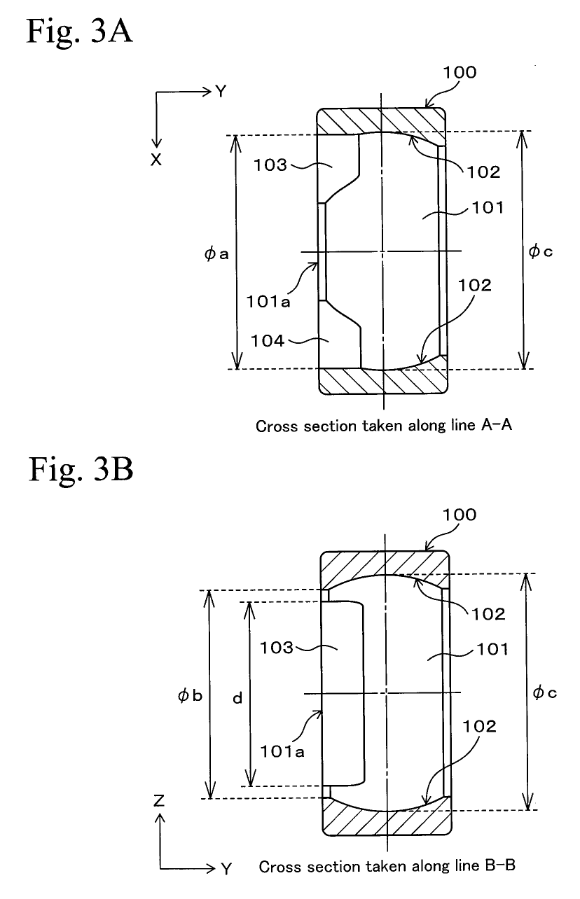

The spherical bearing 10 with resin liner will now be described in detail. FIGS. 2A and 2B show the outer ring 100, FIG. 2A is a perspective view, and FIG. 2B is the front view. FIG. 2B shows the outer ring 100 of the spherical bearing 10 with resin liner viewed in the Y direction in FIG. 2A. FIG. 3A is the cross sectional view of the outer ring 100 taken along the line A-A of FIG. 2B, and FIG. 3B is the cross sectional view of the outer ring 100 taken along the line B-B of FIG. 2B.

As shown in FIGS. 2A to 3B, the outer ring 100 includes a cylindrical outer surface, an inner surface 102 having a concave spherical surface, and a hollow portion 101 at the inside. The inner surface 102 of the outer ring 100 is not entirely formed into a spherical shape and has two openings that are opened by cutting out by X-Z plane at two positions along the Y direction. The opening 101a, which is one of the openings, has an edge portion, and a pair of notched portions 103 and 104 formed at the edge portion.

The notched portions 103 and 104 are formed such that the inner surface having a spherical shape is milled at two locations of the opening 101a side toward the inside (the positive Y direction), and the opening 101a is widened partially at the two locations. The notched portions 103 and 104 may be formed by a method other than milling.

The opening 101a is widened at the notched portions 103 and 104. That is, as shown in FIG. 2B, since the notched portions 103 and 104 are formed, the diameter “Φa” in the X direction of the opening 101a of the inner surface 102 is larger than the opening diameter “Φb” in the Z direction. The edge portion of the opening 101a where the notched portions 103 and 104 are not formed, is a part of the inner surface 102 having a spherical shape (the edge portion of the inner surface 102).

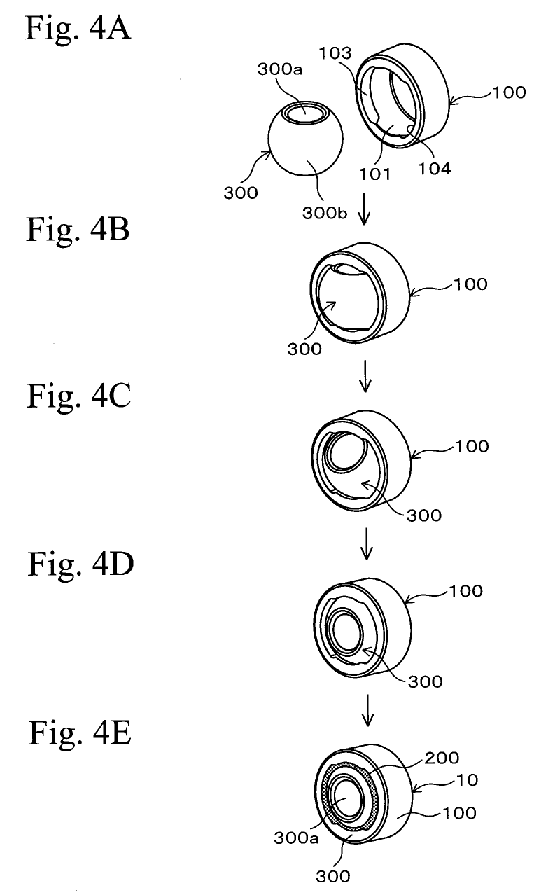

FIGS. 4A to 4E show an example of the assembly process of the spherical bearing 10 with the resin liner 10. FIG. 4A shows the inner ring 300 having a structure in which a spherical body containing a cylindrical hollow portion 300a is cut off at both end portions diametrically opposite along the central axis of the cylindrical hollow portion 300a. A convex spherical surface 300b, which forms the outer surface of the inner ring 300, is contained in the hollow portion 101 with a predetermined clearance between the inner surface 102 of the outer ring 100 having a concave spherical surface.

As shown in FIGS. 2A to 3B, the opening 101a at the end portion of the outer ring 100 has the opening diameter “Φa” in the X direction. Since the opening 101a is formed with the notched portions 103 and 104, the opening diameter “Φa” is larger than the opening diameter “Φb” in the Z direction (Φa>Φb). In addition, the diameter “Φa” is slightly larger than the diameter of the convex spherical surface 300b. The concave spherical surface 102 has a diameter “Φc” that is slightly larger than the diameter “Φa” (Φc>Φa). The diameter “Φc” is larger than the diameter of the convex spherical surface 300b by a predetermined dimensional difference. The notched portions 103 and 104 have a chord length “d”, and the chord length “d” is adjusted so as to be slightly larger than the dimension of the inner ring 300 in the axial direction (the central axis direction of the hollow portion 300a). The spherical surface 102 is maintained in the portion of the opening 101a which is not provided with the notched portions 103 and 104.

Hereinafter, an example of the assembling process of a spherical bearing with resin liner will be described with reference to FIGS. 4A to 4E. First, an outer ring 100 and an inner ring 300 are prepared, and the axis of the inner ring 300 (the axis of a cylindrical hollow portion 300a) is directed toward the diametral direction of the outer ring 100, in which notched portions are not provided (the Z direction in FIGS. 2A and 2B) (the condition shown in FIG. 4A). Then, in a condition shown in FIG. 4A, the inner ring 300 is slid into the outer ring 100, so that the inner ring 300 is inserted into the outer ring 100 at the notched portions. In this case, the diameter “Φa” shown in FIGS. 2A to 3B is slightly larger than the diameter of the convex spherical surface 300b, and the chord length “d” is slightly larger than the length in the axial direction of the inner ring 300. Therefore, as the condition changes from FIG. 4A to FIG. 4B, the inner ring 300 can be inserted into the outer ring 100 at the notched portions.

Since the diameter “Φc” is larger than the diameter of the convex spherical surface 300b by the predetermined dimensional difference, the inner ring 300 in the condition shown in FIG. 4B can be rotated relative to the outer ring 100. That is, the inner ring 300 can be rotated such that the condition thereof changes from that shown in FIG. 4B to FIG. 4C, and to FIG. 4D. FIG. 4D shows a condition in which the central axis of the cylindrical hollow portion 300a of the inner ring 300 coincides with the axis in the direction toward the opening of the hollow portion 101 of the outer ring 100.

The diameter “Φc” is larger than the diameter of the convex spherical surface 300b by the predetermined dimensional difference. Therefore, in the condition shown in FIG. 4D, a clearance exists between the outer ring 100 and the inner ring 300 due to the predetermined dimensional difference. Accordingly, after the relative positions and the relative axis positions of the outer ring 100 and the inner ring 300 are adjusted, the positional relationship thereof is maintained, and the resin is injected into the clearance by the injection molding method. As the resin, a resin based on nylon 6 or nylon 12 may be used.

A resin is injected continuously in the clearance between the outer ring 100 and the inner ring 300 including the notched portions, and the resin is solidified as one body, whereby a spherical bearing 10 with resin liner, which is formed with the resin liner 200, can be obtained (FIG. 4E). When the resin is injected, the resin is sufficiently heated so as to have flowability and to be injected continuously and filling all the space between the outer ring 100 and the inner ring 300 including the notched portions. Then, the resin is solidified so that the outer ring and the resin are bonded together, whereby the resin liner 200 is securely fixed to the outer ring 100, and co-rotation of the resin liner 200 and the inner ring 300 can be prevented.

Thus, the spherical bearing with resin liner 10 has a structure in which the inner ring 300 is rotatable with respect to the outer ring 100. For example, the spherical bearing 10 with resin liner may be used in a condition wherein the inner ring 300 is fixed by passing a shaft member through the cylindrical hollow portion 300a, and the outer ring 100 is fixed to another member. In this case, it is possible to obtain a bearing structure wherein the shaft member is supported such that the shaft member can rotate and can be inclined.

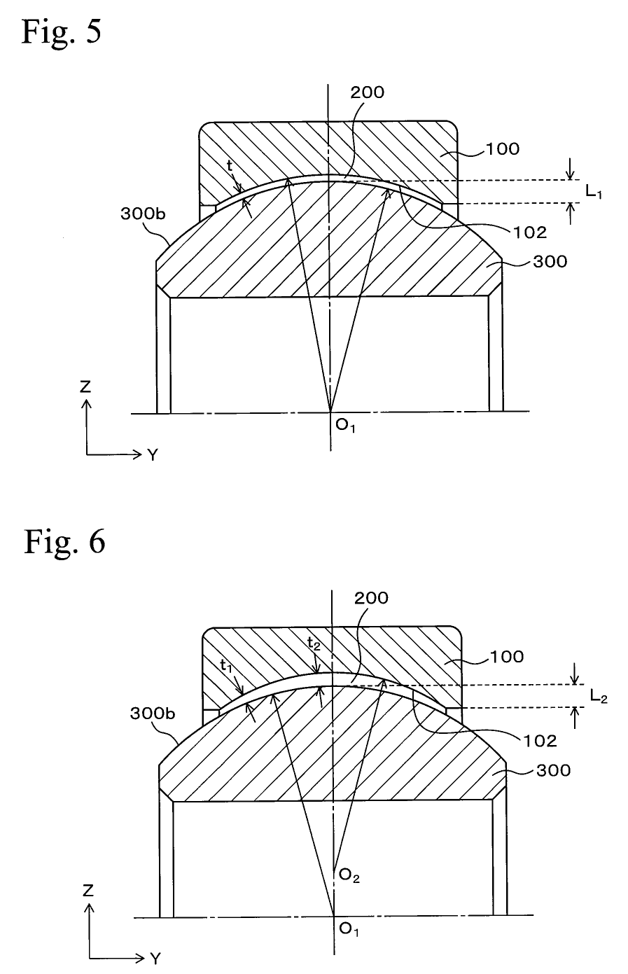

FIGS. 5 and 6 are schematic drawings showing examples of a relationship between the center of curvature of a concave spherical surface inside an outer ring and the center of curvature of a convex spherical surface outside an inner ring. FIGS. 5 and 6 show cross sections of the portion having the largest diameter in the Y-Z plane of FIG. 1, viewed from the X direction.

In the example shown in FIG. 5, the center of curvature of the concave spherical surface 102 and the center of curvature of the convex spherical surface 300b coincide and are positioned at O₁. In this case, when the axes of the outer ring 100 and the inner ring 300 are coincident, the clearance between the concave spherical surface 102 and the convex spherical surface 300b (the thickness of the resin liner 200) has a size “t” and is constant.

In the structure shown in FIG. 5, when the inner ring 300 inserted into the outer ring 100 is viewed from the Y direction, the outer ring 100 and the inner ring 300 overlap with each other at a portion having a thickness L₁. Therefore, when the inner ring 300 is subjected to force in the thrust direction (axial direction), force in the thrust direction of the inner ring 300 is applied to the resin liner 200 at the portion having the thickness L₁, and the force is supported at the inside of the outer ring 100. Accordingly, the critical level when the resin liner 200 deforms and the resin liner 200 comes to be forced out, is increased whereby the inner ring can receive a larger force in the thrust direction compared to the conventional techniques. Moreover, since the size “t” of the clearance is constant, the critical level when the resin liner 200 deforms and the resin liner 200 comes to be forced out can be increased. Thus, the load capacity with respect to the thrust load can be greatly increased.

In the example shown in FIG. 6, the center of curvature of the concave spherical surface 102 is positioned at O₂, and the center of curvature of the convex spherical surface 300b is positioned at O₁. The center of curvature of the concave spherical surface 102 and the center of curvature of the convex spherical surface 300b are not coincident, and O₂ is positioned outside of O₁. That is, the center of curvature O₂ of the spherical surface 102 inside the outer ring 100 is positioned nearer the outer ring 100 than the center of curvature O₁ of the spherical surface 300b. According to this structure, the clearance between the concave spherical surface 102 and the convex spherical surface 300b (the thickness of the resin liner 200) is gradually decreased toward the opening. That is, the size “t₁” of the clearance in the vicinity of the opening is smaller than the size “t₂” of the clearance in the vicinity of the center.

In the structure shown in FIG. 6, when the inner ring 300 inserted into the outer ring 100 is viewed from the Y direction, the outer ring 100 and the inner ring 300 overlap with each other at a portion having a thickness L₂. Therefore, when the inner ring 300 is subjected to a force in the thrust direction, the force in the thrust direction of the inner ring 300 is applied to the resin liner 200, and the force is supported at the inside of the outer ring 100. Accordingly, the critical level when the resin liner 200 deforms and comes to be forced out is increased, whereby the inner ring can receive a larger force in the thrust direction, compared to the conventional techniques. Moreover, since the size “t” of the clearance decreases toward the opening, the resin is not easily forced out compared to the case exemplified in FIG. 5. Therefore, the inner ring can receive a much larger force in the thrust direction compared to the structure exemplified in FIG. 5.

In the structures shown in FIGS. 1 to 6, since the resin forming the resin liner 200 is injected to the notched portions 103 and 104 to fill the space as one body, the function for securing the resin liner 200 inside the outer ring 100 is improved. Therefore, grooves for securing the resin liner 200 inside the outer ring 100 are not necessary, whereby the decrease in the strength of the outer ring 100 due to the formation of the grooves does not occur.

Grooves for securing the resin liner 200 inside the outer ring 100 may be provided at the concave spherical surface 102. In this case, the notched portions 103 and 104 secure the resin liner 200 inside the outer ring 100. Therefore, the depth of the grooves can be smaller than that of the conventional grooves, and the number thereof can be decreased, whereby the decrease in the strength of the outer ring can be reduced. With respect to the shape of the groove, a closed rounded shape or a helix shape may be used, although the groove is discontinuous at the notched portions 103 and 104.

### (2) Second Embodiment

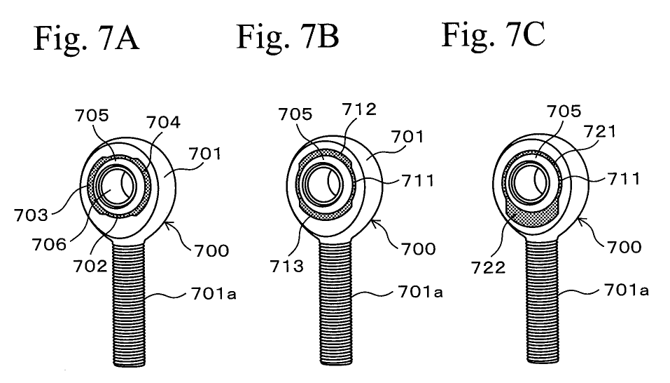

The spherical bearing 10 with resin liner shown in FIG. 1 can be applied for a rod end bearing. FIGS. 7A to 7C are perspective views showing the possible structures of rod end bearings. FIG. 7A shows the rod end bearing 700 as an example 1 according to the present invention. The rod end bearing 700 comprises an outer ring 701 with a screw rod extending in the radial direction (a rod member formed with screws) 701 a formed integrally. Inside the outer ring 701, an inner ring 705 is rotatably supported via a resin liner 702, similarly to the case of the first embodiment. In this structure, portions indicated by reference numerals 703 and 704 are formed as notched portions (the figure shows a condition where the resin material for forming the resin liner was injected).

The rod end bearing 700 shown in FIG. 7A is fixed to a rod member by mounting a screw rod 701a to a counter screw structure (a screw structure that engages with the screw rod 701a) that is provided at the end of the rod member. A shaft of a member that is rotatably supported is inserted into the opening 706 so as to fix it. Thus, a bearing structure supporting the member is obtained. Although a male screw is used for the screw rod 701a in the embodiments of FIGS. 7A to 7C, a female screw may be used as necessary.

FIG. 7B shows an example 2 of the present invention, in which the positions of the notched portions differ from those shown in FIG. 7A. FIG. 7B shows a rod end bearing 700 in which positions of notched portions are rotated by 90° from the condition shown in FIG. 7A, and the notched portions are provided at portions indicated by reference numerals 712 and 713. The rest of the rod end bearing 700 has the same structure as that shown in FIG. 7A.

FIG. 7C shows an example 3 of the present invention, in which only the structure of notched portions differ from those shown in FIG. 7A. FIG. 7C shows a rod end bearing 700 having only one notched portion that is indicated by reference numeral 722. Therefore, the thickness of the notched portion 722 is set to be larger, compared to the cases shown in FIGS. 7A and 7B.

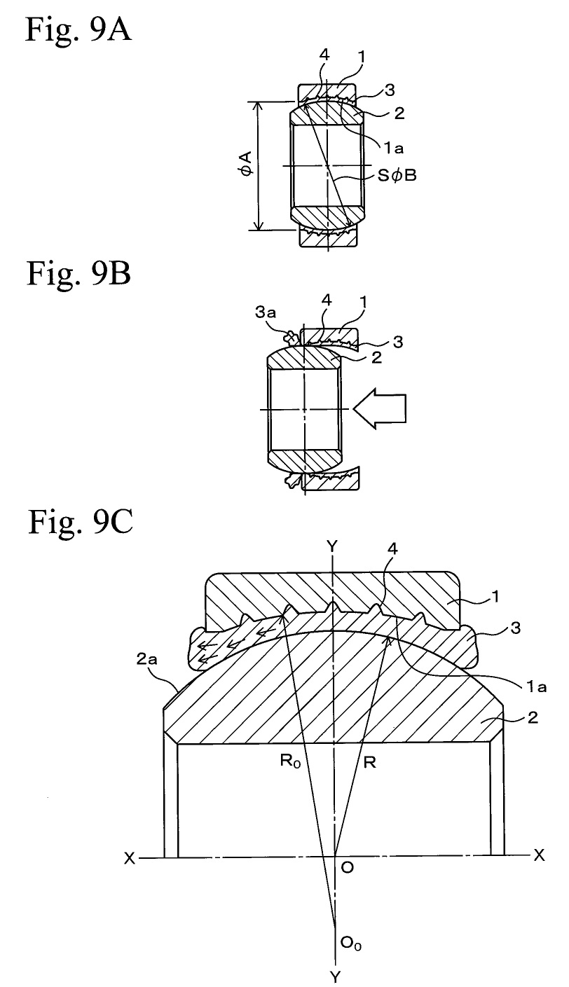

Static load performances with respect to the thrust load of rod end bearings according to the structures shown in FIGS. 7A to 7C were investigated. The results of the investigations are described hereinafter. Push-out load tests were performed on a rod end bearing (conventional article) having a conventional structure without the notched portion as shown in FIGS. 9A to 9C, and on the above-described examples 1 to 3 of the present invention. Table 1 shows the results of the push-out load tests. The conventional article and the examples 1 to 3 of the present invention used the same inner rings and the outer rings with the same outer diameter and width. In the push-out load tests of the examples 1 to 3 of the present invention, a thrust load was applied from the end surface provided with the notched portion toward the end surface not provided with the notched portion. In each case, the push-out load was defined as the maximum load in the load displacement curve obtained by gradually increasing the thrust load. Table 1 shows the comparative values obtained by assuming the push-out load of the conventional article as 100%. As shown in Table 1, the push-out loads of the examples of the present invention are much higher than that of the conventional article.

TABLE 1

| Samples | Extraction load (%) |
|---|---|
| Conventional article | 100 |
| Example 1 of present invention | 293 |
| Example 2 of present invention | 279 |
| Example 3 of present invention | 276 |

### (3) Other Embodiments

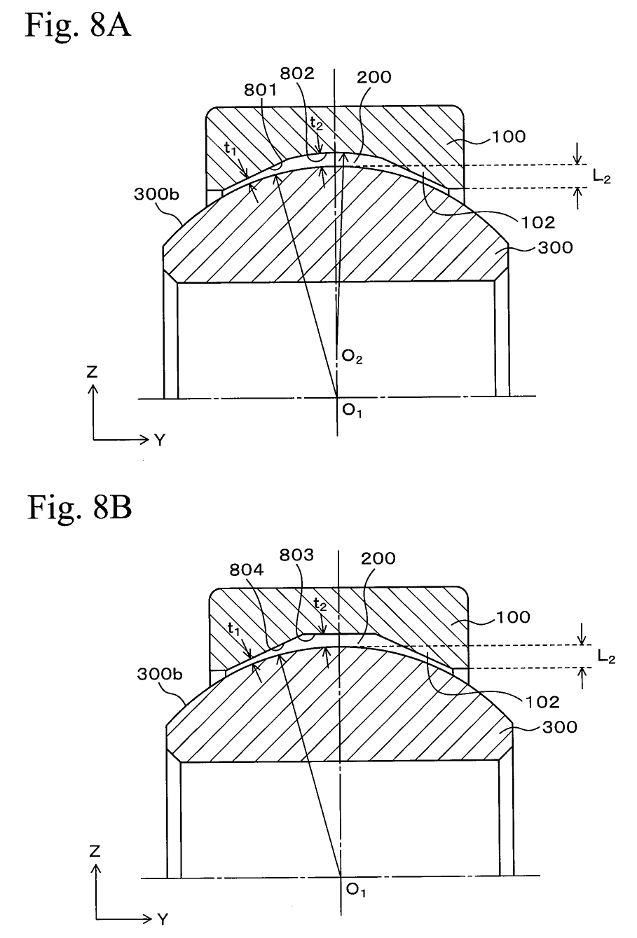

Some examples may be described as a variation of the concave surface shape inside the outer ring. FIGS. 8A and 8B are cross sectional views showing other possible structures of spherical bearing with resin liner according to the present invention. FIG. 8A shows an example of a concave surface inside the outer ring which is formed by a conical surface and a spherical surface, and FIG. 8B shows an example of a concave surface inside the outer ring which is formed by a conical surface and a cylindrical surface. In this case, the description of the portions which are same to those described with reference to FIGS. 5 and 6 will be omitted.

The surface inside the outer ring 100 shown in FIG. 8A has a concave surface formed by a conical surface 801 and a spherical surface 802. The clearance between the conical surface 801 and the outer surface of the inner ring 300 has a size “t₁” that is not constant. The spherical surface 802 has a center of curvature O₂. In this structure, the sizes “t₁” and “t₂” of the clearances decrease toward the opening of the outer ring 300, whereby the resin is not easily forced out, which is similar to the case of the structure exemplified in FIG. 6.

The surface inside the outer ring 100 shown in FIG. 8B has a concave surface formed by a cylindrical surface 803 and a spherical surface 804. In this structure, the clearance has a size “t₁” that decreases toward the opening of the outer ring 300, whereby the resin is not easily forced out, which is similar to the case of the structure exemplified in FIG. 6. In addition, the manufacturing cost can be reduced, compared to the case in which the inner surface is formed by a spherical surface.

The present invention can be used for spherical bearings with resin liner. Moreover, the present invention can be used for rod end bearings provided with a spherical bearing.

What is claimed is:

1. A spherical bearing with resin liner, comprising:
an inner ring having a convex spherical outer surface and a shape in which opposing end portions of a sphere are cut off,
an outer ring having a concave inner surface which faces the outer surface of the inner ring having a predetermined clearance therebetween;
an opening portion provided at the outer ring and having an inner diameter smaller than the outer diameter of the inner ring, the opening portion communicated with a space surrounded by the inner surface of the outer ring;
a notched portion provided at an edge of the opening portion for inserting the inner ring into the outer ring; and
a resin liner portion continuously filling the clearance and the notched portion.

2. The spherical bearing with resin liner according to claim 1, wherein at least a part of the inner surface comprises a concave spherical surface.

3. The spherical bearing with resin liner according to claim 1, wherein the size of clearance decreases from a center portion of the inner surface toward the opening portion.

4. The spherical bearing with resin liner according to claim 2, wherein the concave spherical surface of the inner surface of the outer ring has a center of curvature that is positioned nearer the outer ring than a center of curvature of the convex spherical outer surface of the inner ring is.

5. A rod end bearing comprising:
the spherical bearing with resin liner according to claim 1; and
a screw portion provided at the outer ring and extending in a radial direction.
